(19) United States
(12) Patent Application Publication
(10) Pub. No.: US 2007/0272630 A1
(43) Pub. Date: Nov. 29, 2007

(54) Desktop Document-Rack Structure

(76) Inventor: Fortunato De Luca, Teramo (IT)

Correspondence Address: HOGAN & HARTSON LLP;IP GROUP, COLUMBIA SQUARE, 555 THIRTEENTH STREET, N.W., WASHINGTON, DC, 20004, US

(21) Appl. No.: 10/582,484

(22) PCT Filed: Dec. 2, 2004
(86) PCT No.: PCT/EP04/13719

§ 371 Date: Jul. 2, 2007

(30) Foreign Application Priority Data
Dec. 11, 2003 (IT) RM2003U000210

(51) Int. Cl. B42F 17/00; B42F 17/02

(52) U.S. Cl. 211/11

(57) ABSTRACT

Described is a document-rack structure consisting of a supporting base (10), a wall (12) integral with the supporting base and a multiplicity of divider panels (15) attached by means of tongue-and-groove joints to the supporting base (10) on one side and to the wall (12) on another side, so that between them and together with the upper surface (11) of the supporting base they come to form separate document-rack spaces. The upper surface is shaped in such a manner that the bottom surface of at least some of these spaces is inclined with respect to the horizontal. The structure renders possible an orderly arrangement of cartaceous documents and ready visibility and accessibility of these documents.

The present invention relates in general to office accessories and, more particularly, to a desktop document-rack structure.

As is well known, the need for filing cartaceous documents of various types in an orderly manner is felt in any kind of office. At times documents have not only be ordered, but must also be rapidly accessible on the desk. To this end use is made, for example, of filing trays, so-called correspondence baskets that can be stacked and also other document-rack structures, known in Italian also as “sparticarte” (literally “document dividers”, but to all intents and purposes “document racks”).

The stackable document trays make it possible to file many documents by subdividing them in an orderly manner into as many groups as the number of available trays. Nevertheless, this solution is associated with the drawback that the documents contained in each tray cannot be examined quickly, because they are superposed and cannot be separated for examination unless they are completely removed from their tray.

The known document racks are simple structures substantially consisting of a base and such divider elements as uprights or small arches of different heights attached to the base. They make it possible for different documents to be kept separate in a vertical position, but do not permit these documents to be filed in an orderly manner, because the documents tend to assume positions of different inclination and to bend. Furthermore, the divider elements are not readily visible when the documents are in position, so that the utility of these structures is often somewhat questionable.

With a view to obviating these drawbacks, the present invention makes available a document-rack structure comprising a supporting base, a wall-integral with the supporting base and a multiplicity of divider panels attached by means of tongue-and-groove joints to the supporting base on one side and to the wall on another side, so that between them and together with the upper surface of the supporting base they come to form document-rack spaces; the upper surface is shaped in such a manner that the bottom surface of at least some of these spaces is inclined with respect to the horizontal.

The invention will be more readily understood from the following detailed description of one of its embodiments that makes reference to the attached drawings, the figures of which show, in perspective and as seen from above, the structure in accordance with the invention and, more precisely:

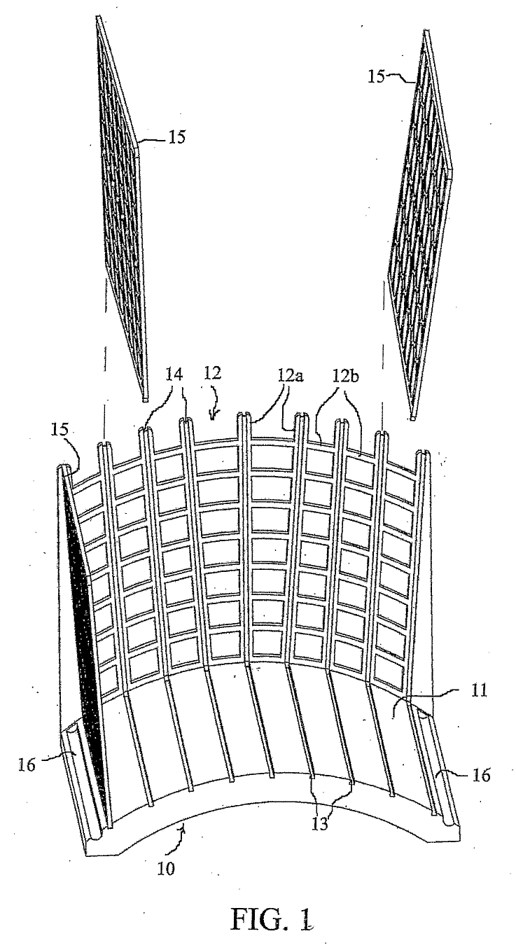

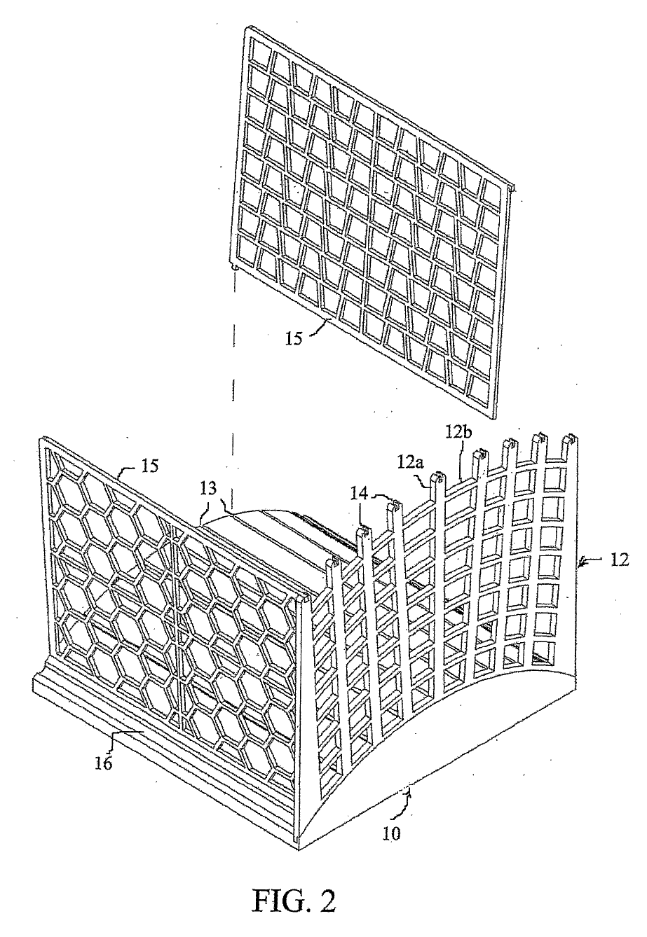

FIGS. 1 and 2 are two views, respectively from in front and from behind, of the structure with the parts detached and

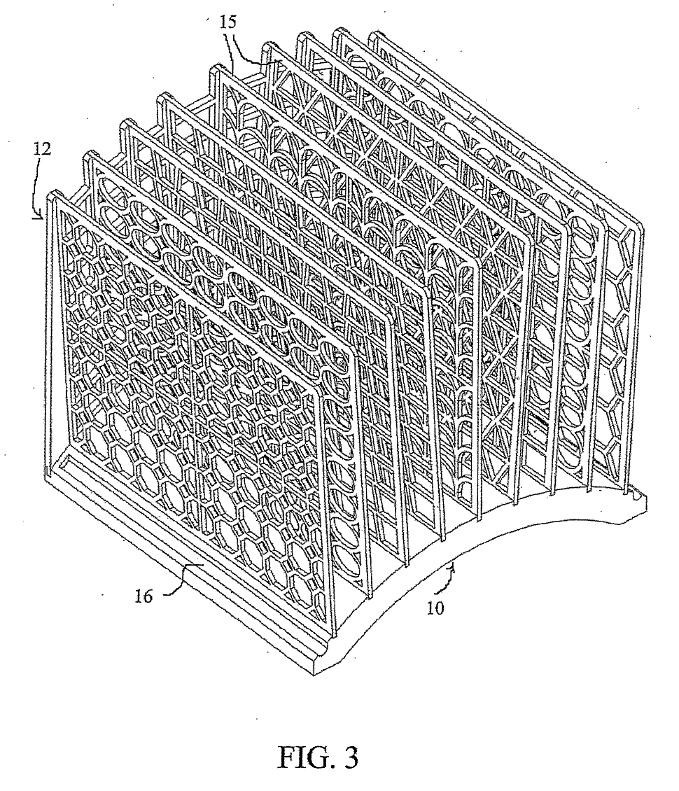

FIG. 3 is a front view of the complete structure.

As can be seen from the drawings, the structure in accordance with the invention consists of a supporting base 10 that has a cylindrical upper surface 11 with the concavity pointing downwards and a wall 12 integral with the base 10. In this particular example, the wall 12 is formed by uprights 12a kept together by cross-pieces 12b. The wall 12 is attached to the base or formed as a single piece with it. In the latter case the two parts may be made of plastic material in a single operation of some usual injection moulding process.

The supporting base 10 is provided on its upper surface 11 with a multiplicity of parallel grooves 13 (which are nine in number in the example illustrated by the drawing) that link with a like number of grooves 14 provided on the sides of the uprights 12a and running towards the base.

The grooves 13 and 14 constitute seatings for the edges of the nine panels 15, made of plastic material for example, of a thickness such as to assure good tongue-and-groove attachment to the supporting base 10. In this example the panels are constituted by reticular structures having different configurations and identical dimensions, but all of them could also have the same appearance and/or different dimensions.

The spaces delimited by the panels (FIG. 3) constitute document-carrier racks for the orderly insertion of documents in the form of sheets or folders.

Thanks to the curvature of the upper surface of the base, the bottom surfaces of the spaces are inclined with respect to the horizontal. This inclination has the effect that the sheets that are inserted in each space tend to assume a preferential inclination, so that they become arranged in an orderly manner and can be readily separated for examination. Looking for a document thus becomes easy and rapid.

Preferably, the divider panels 15 are arranged in a radial pattern: in particular, in the example here illustrated the central panel is in a vertical position and the other panels are slightly inclined with respect to the vertical, for example, by 4° in the clockwise direction or in the anti-clockwise direction for the panels, respectively, to the right or the left of the central panel as seen in FIG. 1. This distribution once again contributes to assuring that the documents will tend to arrange themselves in accordance with a predetermined inclination.

Advantageously, on the surface 11 there may be provided ribs parallel to the grooves or other upstands or recesses (not shown on the drawings) that will avoid or at least reduce the tendency to fold of the sheets arranged in the spaces, which naturally contributes to an orderly arrangement of the sheets and therefore facilitates their separation for examination.

In the illustrated example the supporting base 10 is shaped in such a manner as to present in proximity of its rectilinear sides two little channels 16 intended to constitute spaces where pens and pencils can be deposited.

According to a variant of the structure described above, which is easy to imagine and has therefore not been illustrated, the upper surface of the support base may be shaped as an inclined plane rather than as a cylindrical surface. In this case, once again, the divider panels may be slightly inclined with respect to the vertical (but in this case all in the same sense).

1. A document-rack structure comprising a supporting base (10), a wall (12) integral with the supporting base and a multiplicity of divider panels (15) attached by means of tongue-and-groove joints to the supporting base (10) on one side and to the wall (12) on another side, so that between them and together with the upper surface (11) of the supporting base they come to form separate document-rack spaces, said upper surface being shaped in such a manner that the bottom surface of at least some of these spaces is inclined with respect to the horizontal.

2. A structure in accordance with claim 1, wherein the upper surface (11) of the supporting base (10) is a cylindrical surface with the concavity pointing downwards.

3. A structure in accordance with claim 2, wherein the divider panels (15) are arranged in a radial pattern.

4. A structure in accordance with claim 1, wherein the upper surface of the supporting base is an inclined plane.

5. A structure in accordance with claim 4, wherein at least some of the panels are inclined with respect to the vertical.

6. A structure in accordance with claim 1, wherein the supporting base (10) and the wall (12) are provided with grooves for attaching the divider panels (15) by means of tongue-and-groove joints.

7. A structure in accordance with claim 1, wherein the bottom surface of the document-rack spaces is provided with protuberances.

8. A structure in accordance with claim 1, wherein the bottom surface of the document-rack spaces is provided with rectilinear incisions.

9. A structure in accordance with claim 1, wherein the supporting base (10) and the wall (12) are a single piece moulded from plastic material.

10. A structure in accordance with claim 1, wherein the wall (12) comprises a multiplicity of uprights (12a) kept together by cross-pieces (12b).
